(19) United States
(12) Patent Application Publication
(10) Pub. No.: US 2009/0248514 A1
(43) Pub. Date: Oct. 1, 2009

(54) SYSTEM AND METHOD FOR DETECTING THE SENSITIVITY OF WEB PAGE CONTENT FOR SERVING ADVERTISEMENTS IN ONLINE ADVERTISING

(75) Inventors: Bo Pang, Sunnyvale, CA (US); Massimiliano Ciaramita, Barcelona (ES)

Correspondence Address: Law Office of Robert Bolan, P.O. Box 36, Bellevue, WA, 98009, US

(73) Assignee: Yahoo! Inc., Sunnyvale, CA (US)

(21) Appl. No.: 12/060,819

(22) Filed: Apr. 1, 2008

(51) Int. Cl. G06Q 30/00

(52) U.S. Cl. 705/14

(57) ABSTRACT

An improved system and method for detecting the sensitivity of web page content for serving advertisements in online advertising is provided. A web page sensitivity classifier may be provided for identifying the sensitivity of the content of a web page to an advertisement. The web page sensitivity classifier may use the features of a web page and the features of each advertisement in a list of candidate advertisements to identify advertisements that do not match the sensitivity of the content of the web page. Any advertisements that do not match the sensitivity of the content of the web page may be removed form the list of candidate advertisements. Web page placements may be allocated for advertisements from the list of candidate advertisements that match the sensitivity of the content of the web page, and the advertisements may be served for display.

### FIELD OF THE INVENTION

The invention relates generally to computer systems, and more particularly to an improved system and method for detecting the sensitivity of web page content for serving advertisements in online advertising.

### BACKGROUND OF THE INVENTION

Operators of websites offering online content may manage an inventory of advertisements that may be shown to visitors viewing content of a website. When a user may visit a website, the operator of the website or a third party may choose to show one or more advertisements to the user with the expectation that the user may select an advertisement to buy advertised goods or services. Advertisers may bid to have their advertisement shown to a visitor viewing particular content of the website. Or the operator of the website or third party may choose the advertisement and may generate revenue whenever a visitor may select an advertisement shown while viewing content of the website.

Most current approaches for choosing advertisements that match the content of a requested web page only consider how well the advertisements match the topic of the content of the web page. Although advertisements with topics related to the subject matter of a web page may be relevant, choosing an advertisement solely on the basis that the topic matches a topic of a web page fails to consider whether the advertisement is appropriate for the context of the document. Such an approach may also fail to consider whether the opinions and sentiments expressed in a web page may be appropriate for specific advertisements with related topics. For example, placing advertisements for display with a web page displaying news about a war or a disaster may be considered inappropriate and even offensive. Similarly, placing an advertisement for a company or product along with a web page article expressing negative opinions about the company or product may also be inappropriate. Neither the advertiser nor the user will find the advertisement appropriate. As another example, placing adult or sexually-oriented advertisements in unrelated content pages will also be considered both inappropriate and offensive. As the online publishing and advertisement industry grows, there needs to be better optimization in matching advertisements to web pages to reflect the context of the web page content.

What is needed is a way to recognize the context of web page content beyond simply its topic in order to reduce serving inappropriate advertisements. Such a system and method should improve the user experience and increase revenue for advertisers and website operators.

### SUMMARY OF THE INVENTION

Briefly, the present invention provides a system and method for detecting the sensitivity of web page content for serving advertisements in online advertising. A web page sensitivity classifier may be provided for identifying the sensitivity of the content of a web page to an advertisement. In particular, a statistical classifier, for instance, may be trained using pairs of a web page and an advertisement, each represented by features. In addition, the training data may also include a classification of the sensitivity of the web page to the advertisement for each pair. The features of each pair of a web page and advertisement may be used to train a statistical classifier to identify the sensitivity of an unseen web page to an unseen advertisement. Any type of statistical classifier may be used including a support vector machine, a naïve Bayes classifier, or other type of statistical classifier.

In an embodiment, an advertisement serving engine may be provided for serving one or more advertisements for display with content of a web page. In general, a list of candidate advertisements may be received for display with the web page, and advertisements from the list of candidate advertisements may be identified that do not match the sensitivity of the content of the web page. The web page sensitivity classifier may use the features of each web page and the advertisement to classify the sensitivity of the content of the web page to each of the advertisements. Advertisements identified from the list of candidate advertisements that do not match the sensitivity of the content of the web page may be removed. Web page placements may be allocated for advertisements from the list of candidate advertisements that match the sensitivity of the content of the web page, and the advertisements may be served for display in the allocated web page placements.

The present invention may support many applications for detecting the sensitivity of web page content for serving advertisements in online advertising. For example, online content publishing applications may use the present invention to select a list of advertisements that match the sensitivity of the content of a web page for display with content requested by a user. Similarly, ecommerce applications may use the present invention to select a list of advertisements that match the sensitivity of the product information requested by a user. Or online search advertising applications may use the present invention to identify and remove advertisements that do not match the sensitivity of the content of search results from a list of candidate advertisements predicted to be relevant for display with search results to a user. For any of these online applications, the sensitivity of web page content may be detected by the present invention for serving advertisements in online advertising.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for detecting the sensitivity of web page content for serving advertisements in online advertising, in accordance with an aspect of the present invention;

FIG. 3 is a flowchart generally representing the steps undertaken in one embodiment for training a classifier to detect the sensitivity of web page content for serving advertisements, in accordance with an aspect of the present invention;

FIG. 4 is a flowchart generally representing the steps undertaken in one embodiment for classifying the sensitivity of the content of a web page to an advertisement, in accordance with an aspect of the present invention; and

FIG. 5 is a flowchart generally representing the steps undertaken in one embodiment for detecting the sensitivity of web page content for serving advertisements in online advertising, in accordance with an aspect of the present invention.

### DETAILED DESCRIPTION

### Exemplary Operating Environment

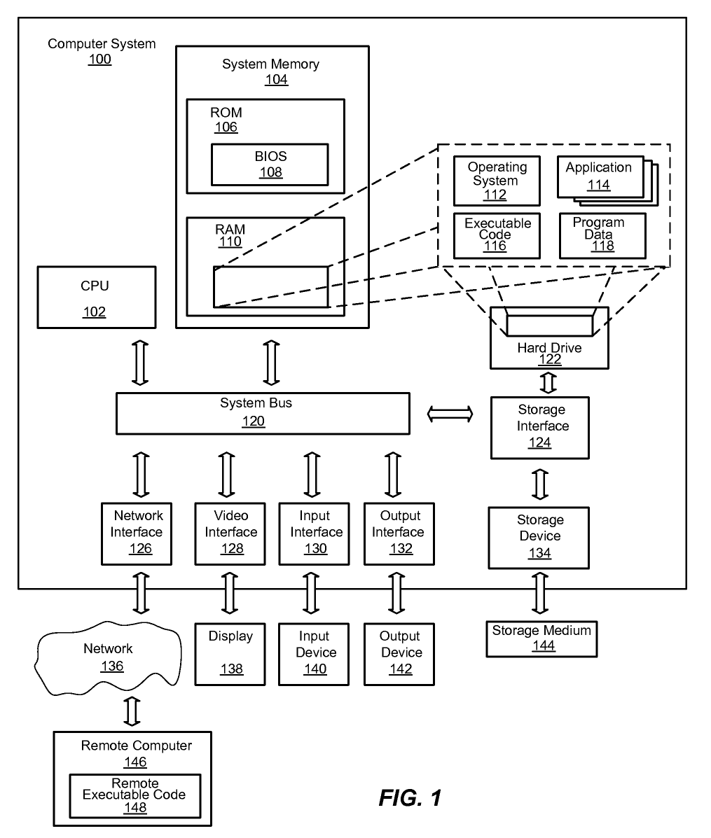

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Detecting the Sensitivity of Web Page Content for Serving Advertisements in Online Advertising

The present invention is generally directed towards a system and method for detecting the sensitivity of web page content for serving advertisements in online advertising. The web page sensitivity classifier may use the features of a web page and the features of each advertisement in a list of candidate advertisements to identify advertisements that do not match the sensitivity of the content of the web page. Any advertisements that do not match the sensitivity of the content of the web page may be removed form the list of candidate advertisements. Web page placements may be allocated for advertisements from the list of candidate advertisements that match the sensitivity of the content of the web page, and the advertisements may be served for display.

As will be seen, applications that may display advertisements to users who visit a web site, including managed content properties, may use the present invention to serve advertisements that may not only be relevant but also appropriately match the sensitivity of the context of the content requested by a user. As will be understood, the various block diagrams, flow charts and scenarios described herein are only examples, and there are many other scenarios to which the present invention will apply.

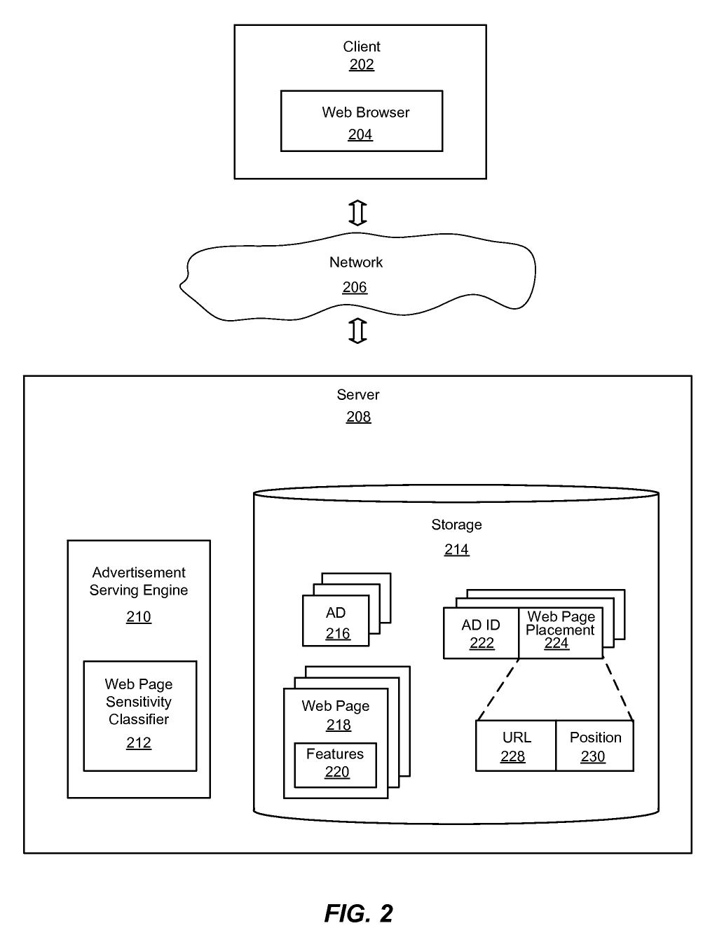

Turning to FIG. 2 of the drawings, there is shown a block diagram generally representing an exemplary architecture of system components for detecting the sensitivity of web page content for serving advertisements in online advertising. Those skilled in the art will appreciate that the functionality implemented within the blocks illustrated in the diagram may be implemented as separate components or the functionality of several or all of the blocks may be implemented within a single component. For example, the functionality for the web page sensitivity classifier 212 may be implemented as a separate component from the advertisement serving engine 210. Or the functionality of the web page sensitivity classifier 212 may be implemented on another computer as a separate component from the server 208. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a request for content which may be input by a user and for sending the request to a server to obtain the requested content. In general, the web browser 204 may be any type of interpreted or executable software code such as a kernel component, an application program, a script, a linked library, an object with methods, and so forth. In various embodiments, other applications may be used for sending a request for content, including an email application requesting a message from an inbox, an ecommerce application requesting product information, and an online search advertising application requesting search results for a query, and so forth.

The server 208 may be any type of computer system or computing device such as computer system 100 of FIG. 1. In general, the server 208 may provide services for processing requests for content and may include services for providing a list of advertisements to accompany the content requested. In particular, the server 208 may include an advertisement serving engine 210 for serving one or more advertisements for display with the requested content. The advertisement serving engine 210 may include a web page sensitivity classifier 212 for identifying the sensitivity of the content of a web page to an advertisement. Each of these modules may also be any type of executable software code such as a kernel component, an application program, a linked library, an object with methods, or other type of executable software code.

The server 208 may be operably coupled to computer-readable storage media such as storage 214 that may store any type of advertisements 216 and web pages 218 that may be represented by a set of features 220. In an embodiment, an advertisement 216 may be displayed according to a web page placement 224. An advertisement ID 222 associated with an advertisement 216 may be allocated to a web page placement 224 may include a Uniform Resource Locator (URL) 228 for a web page and a position 230 for displaying an advertisement on the web page. In various embodiments, a web page may be any information that may be addressable by a URL, including a document, an image, audio, and so forth.

There may be many applications which may use the present invention for detecting the sensitivity of web page content for serving advertisements in online advertising. For example, online content publishing applications may use the present invention to select a list of advertisements that match the sensitivity of the content of a web page for display with content requested by a user. Similarly, ecommerce applications may use the present invention to select a list of advertisements that match the sensitivity of the product information requested by a user. Or online search advertising applications may use the present invention to identify and remove advertisements that do not match the sensitivity of the content of search results from a list of candidate advertisements predicted to be relevant for display with search results to a user. For any of these online applications, the sensitivity of web page content may be detected by the present invention for serving advertisements in online advertising.

In an embodiment, a statistical classifier may be trained for binary classification of the sensitivity of the content of a web page to an advertisement. There may be a training corpus of training pairs, each pair representing a web page and an advertisement. Each web page may be represented by features and labeled to indicate whether the content of the web page may be sensitive to the advertisement. The features of a web page may include text represented as a dimensional vector of words, the topic of the web page, domain information and/or clustering features generated from unlabeled web pages. Each advertisement may similarly be represented by features including text represented as a dimensional vector of words, topic of the advertisement, clustering features generated from unlabeled advertisements, and so forth.

The features of each pair of a web page and advertisement may be used to train a statistical classifier to identify the sensitivity of an unseen web page to an unseen advertisement. The statistical classifier may be a support vector machine, a naïve Bayes classifier, or other type of statistical classifier. Those skilled in the art will appreciate that other methods may be used for binary classification including collective inference.

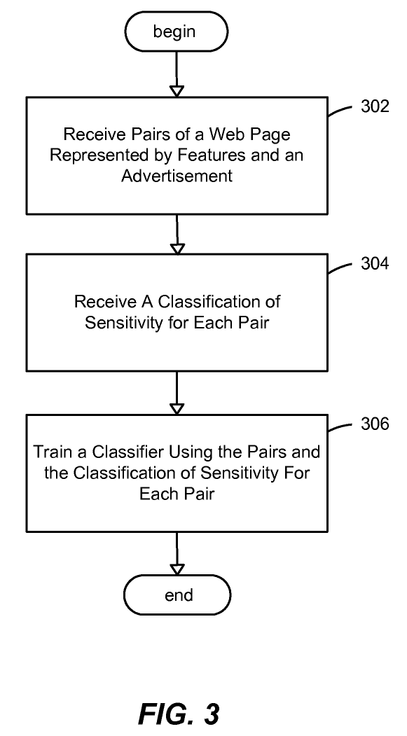

FIG. 3 presents a flowchart generally representing the steps undertaken in one embodiment for training a classifier to detect the sensitivity of web page content for serving advertisements in online advertising. At step 302, pairs of an advertisement and a web page, each represented by features, may be received for training a classifier to detect the sensitivity of web page content for serving advertisements. In an embodiment, the features may include text represented as a dimensional vector of words, a topic, clustering features, an so forth. At step 304, a classification of the sensitivity of the web page to the advertisement may be received for each pair. For instance, a label may be received as a feature of the web page to indicate whether the content of the web page may be sensitive to the advertisement. Such a label may be generated for the training data by a human being who reviews the content of the web page and the advertisement. In an embodiment, the label may represent a binary classification of the sensitivity of the web page to the advertisement. In another embodiment, the label may represent a score that can be interpreted as the probability that the web page is sensitive to the advertisement.

At step 306, a statistical classifier may be trained using the pairs and the classification of the sensitivity of the content of the web page to the advertisement in each pair. For instance, a statistical classifier may apply naïve Bayesian techniques using for example the frequency of different text appearing in the content of the web page and the advertisement in an embodiment to learn the probability that the web page is sensitive to an advertisement. Or a Support Vector Machine (SVM) may be employed in another embodiment to automatically learn classification of the sensitivity of a web page to an advertisement from examples. Consider i to represent an index for pairs of a web page and an advertisement 1 . . . n, and j to represent an index for features 1 . . . d for each pair of a web page and advertisement. A training set {(xᵢ,yᵢ)}_{1≦i≦n} may be given, where xᵢ≡(xᵢ₁ . . . x_{id})^{T} is the d dimensional vector representation of the i-th example and yᵢ is its label where yᵢ=1 or yᵢ=−1. For example, label, yᵢ, may be assigned a value of 1 if the sensitivity of the pair of a web page and advertisement matches; otherwise, yᵢ may be assigned a value of −1. A linear classier may use a d dimensional weight vector, w, with the classification function defined by f(x)=w·x. Consider w² to denote the square of the Euclidean norm of w. The SVM may minimize the following objective function:

$$\frac{1}{2} {w}^{2} + \frac{C}{2} {\sum }_{i = 1}^{n} l ( {y}_{i} ( w \cdot {x}_{i} ) ) ,$$

where l may represent a loss function, l(t)=max(0,1−t)^{p}. Commonly used values for p are: p=1 and p=2. Advantageously, fast methods exist to train SVMs.

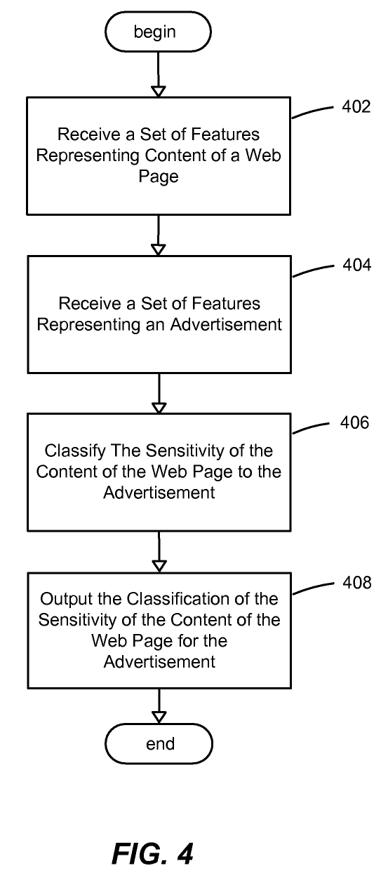

Once a classifier may be trained to detect the sensitivity of web page content to an advertisement, the classifier may be applied to identify the sensitivity of an unseen web page to an unseen advertisement. FIG. 4 presents a flowchart generally representing the steps undertaken in one embodiment for classifying the sensitivity of the content of a web page to an advertisement. At step 402, a set of features representing a web page may be received. In an embodiment, the features of a web page may include text represented as a dimensional vector of words, the topic of the web page, domain information and/or clustering features generated from unlabeled web pages. At step 404, a set of features representing an advertisement may be received. Each advertisement may similarly be represented by features including text represented as a dimensional vector of words, the topic of the advertisement, clustering features generated from unlabeled advertisements, and so forth. Importantly, using a combination of discriminative features, including terms, a topic, and clustering features, may provide an enhanced ability to distinguish web pages that are sensitive to an advertisement from those that are not sensitive. At step 406, the sensitivity of the web page to the advertisement may be classified using a trained classifier. And at step 408, the classification of the sensitivity of the web page to the advertisement may be output. The output of the classification of the sensitivity of the web page may be binary in an embodiment, or the output of the classification of the sensitivity may be a score in another embodiment that may represent the probability that the web page is sensitive to the advertisement.

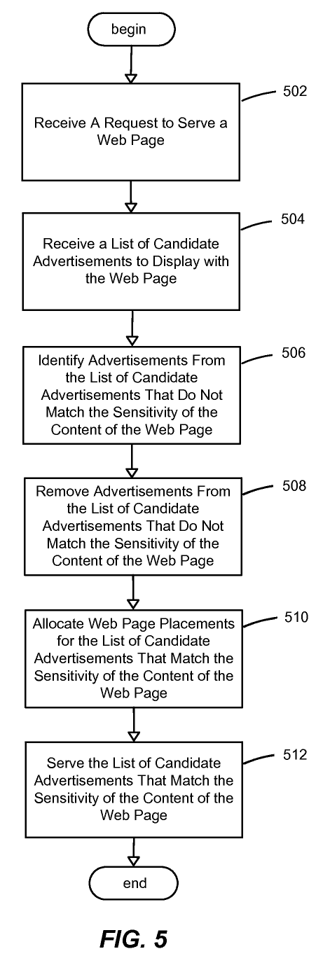

The ability to classify the sensitivity of the context of content of a web page to an advertisement may improve the quality of a general advertisement serving system, and correspondingly increase revenue for advertisers and website operators. FIG. 5 presents a flowchart generally representing the steps undertaken in one embodiment for detecting the sensitivity of web page content for serving advertisements in online advertising. At step 502, a request to serve a web page may be received, for instance, by an advertisement serving engine. For example, a request sent from a web browser to a server to obtain web page content requested by a user may be forwarded to an advertisement serving engine along with a set of features representing the content of the web page. Or, the request may be sent from a search engine and may include the set of features representing the content of the search results page.

At step 504, a list of candidate advertisements to display with the web page may be received. For an online publishing advertising application, a list of candidate advertisements selecting by relevance of matching content may be received. Or for a sponsored search advertising application, the list of candidate advertisements may be selected by a keyword auction. In any case, advertisements from the list of candidate advertisements may be identified at step 506 that do not match the sensitivity of the content of the web page. In one embodiment, the sensitivity of the content of a web page to an advertisement may be identified by classification of the pair of the web page and the advertisement using the steps described in conjunction with FIG. 4 described above.

At step 508, advertisements identified from the list of candidate advertisements that do not match the sensitivity of the content of the web page may be removed. A step 510, web page placements may be allocated for the list of candidate advertisements that match the sensitivity of the content of the web page. For an online publishing advertising application, web page placements may be allocated for displaying advertisements along with the content requested. Or for a sponsored search advertising application, web page placements may be allocated for the sponsored search area of the search results page displayed to a user. At step 512, the list of advertisements that match the sensitivity of the content of the web page may be served for display in the allocated web page placements.

Thus the present invention may be used by applications that may display advertisements to users who visit a website, including managed content properties, to serve advertisements that may not only be relevant but also appropriately match the sensitivity of the context of the content requested by a user. Advantageously, a classifier may be trained using a combination of features, including terms, a topic, and clustering features, that may provide the ability to discriminate web pages that are sensitive to an advertisement from those that are not sensitive, without requiring the creation of a taxonomy designed specifically for this task. As a result, not only may the effort of annotation be significantly reduced, but the ability to discriminate may not be restricted by the limitations imposed in the design of the taxonomy. Moreover, the features derived in classifying the sensitivity of the content of a web page to an advertisement may be used for ranking the relevance of the advertisement even if the web page may not be classified as sensitive to the advertisement. Thus, the present invention may also be used to improve the quality of advertisement ranking in online advertising applications.

As can be seen from the foregoing detailed description, the present invention provides an improved system and method for detecting the sensitivity of web page content for serving advertisements in online advertising. The system and method may use the features of a web page and the features of each advertisement in a list of candidate advertisements to identify advertisements that do not match the sensitivity of the content of the web page. Web page placements may be allocated for advertisements from the list of candidate advertisements that match the sensitivity of the content of the web page, and the advertisements may be served for display. For online content publishing applications, the present invention may be used to select a list of advertisements that match the sensitivity of the context of content of a web page for display with content requested by a user. Similarly, ecommerce applications may use the present invention to select a list of advertisements that match the sensitivity of the product information requested by a user. Or online search advertising applications may use the present invention to identify and remove sponsored advertisements that do not match the sensitivity of the content of search results from a list of candidate advertisements predicted to be relevant for display with search results to a user. Accordingly, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for online advertising, comprising:
a web page sensitivity classifier for classifying the sensitivity of content of a web page to an advertisement for display to a user;
an advertisement serving engine operably coupled to the web page sensitivity classifier for serving at least one advertisement allocated a web page placement for display to the user; and
a storage operably coupled to the advertising serving engine for storing a plurality of advertisements that may be allocated web page placements for display with content of the web page.

2. The system of claim 1 further comprising a web browser operably coupled to the advertising serving engine for receiving the at least one advertisement allocated the web page placement for display to the user.

3. The system of claim 1 wherein the web page sensitivity classifier comprises a statistical classifier.

4. A computer-readable medium having computer-executable components comprising the system of claim 1.

5. A computer-implemented method for online advertising, comprising:
receiving a plurality of candidate advertisements for display with content of a web page;
removing at least one advertisement that does not match sensitivity of the content of the web page from the plurality of candidate advertisements; and
serving at least one advertisement from the remainder of the plurality of candidate advertisements for display with the content of the web page.

6. The method of claim 5 further comprising receiving a request to serve online content to a web browser.

7. The method of claim 5 further comprising identifying that the at least one advertisement does not match the sensitivity of the content of the web page from the plurality of candidate advertisements.

8. The method of claim 5 further comprising allocating the at least one advertisement from the remainder of the plurality of candidate advertisements for display with the content of the web page.

9. The method of claim 5 wherein removing at least one advertisement that does not match the sensitivity of the content of the web page from the plurality of candidate advertisements comprises receiving a plurality of features representing the content of the web page.

10. The method of claim 5 wherein removing at least one advertisement that does not match the sensitivity of the content of the web page from the plurality of candidate advertisements comprises receiving a plurality of features representing the advertisement.

11. The method of claim 5 wherein removing at least one advertisement that does not match the sensitivity of the content of the web page from the plurality of candidate advertisements comprises classifying the sensitivity of the content of the web page to the advertisement.

12. The method of claim 5 wherein removing at least one advertisement that does not match the sensitivity of the content of the web page from the plurality of candidate advertisements comprises outputting a classification of the sensitivity of the content of the web page to the advertisement.

13. The method of claim 11 wherein classifying the sensitivity of the content of the web page to the advertisement comprises applying a classifier trained using a classification for each of a plurality of pairs of a web page represented by a plurality of features and an advertisement represented by a plurality of features.

14. The method of claim 11 wherein classifying the sensitivity of the content of the web page to the advertisement comprises applying binary classification using a plurality of features representing the content of the web page and a plurality of features representing the advertisement.

15. The method of claim 14 wherein the plurality of features representing the content of the web page comprises text represented as a dimensional vector of words.

16. The method of claim 14 wherein the plurality of features representing the advertisement comprises a topic.

17. A computer-readable medium having computer-executable instructions for performing the method of claim 5.

18. A computer system for online advertising, comprising:
means for classifying sensitivity of content of a web page to an advertisement;
means for identifying that the advertisement matches the sensitivity of the content of the web page; and
means for serving the advertisement for display with the content of the web page.

19. The computer system of claim 18 further comprising:
means for identifying that the advertisement does not match the sensitivity of the content of the web page; and
means for removing the advertisement from a plurality of candidate advertisements for display with the content of the web page.

20. The computer system of claim 18 further comprising means for training a classifier for classifying the sensitivity of the content of the web page to the advertisement.
